(19) United States
(12) Patent Application Publication
(10) Pub. No.: US 2021/0354023 A1
(43) Pub. Date: Nov. 18, 2021

(54) SYSTEMS AND METHODS FOR AUGMENTED REALITY-BASED INTERACTIVE PHYSICAL THERAPY OR TRAINING

(71) Applicant: SIN EMERGING TECHNOLOGIES, LLC, Milwaukee, WI (US)

(72) Inventors: Todd SINCLAIR, Sturgeon Bay, WI (US); Daniel BITTER, St. Ann, MO (US); Angelo KASTROULIS, Jacksonville Beach, FL (US)

(73) Assignee: SIN EMERGING TECHNOLOGIES, LLC, Milwaukee, WI (US)

(21) Appl. No.: 17/318,857

(22) Filed: May 12, 2021

Related U.S. Application Data
(60) Provisional application No. 63/024,330, filed on May 13, 2020.

(51) Int. Cl. A63B 71/06; G06T 7/73; G06T 19/00; H04N 13/204; G06K 9/00; H04N 13/332; A63B 24/00

(52) U.S. Cl. CPC A63B 71/0622; A63B 2024/0009; G06T 19/006; H04N 13/204; G06K 9/00369; H04N 13/332; A63B 24/0062; A63B 24/0006; G06T 2207/30196; G06T 2207/10012; A63B 2071/0636; A63B 2071/0647; A63B 2220/05; A63B 2220/807; A63B 2220/806; A63B 2220/24; G06T 7/74

(57) ABSTRACT

In some aspects, the disclosure is directed to methods and systems for body tracking systems and augmented reality interfaces. These systems provide an augmented reality application that enables a user to accurately perform physical therapy or training exercises at home and enable real time monitoring and communication between the user and a remote physician or trainer. Using motion tracking capabilities of depth cameras and/or multiple camera setups, the system can create a real time three dimensional model that mirrors or guides the patient's movements and can show the patient how to properly perform an exercise with dynamic interactive feedback. The tracking capabilities further provide physicians with detailed measurements as well as tracking improvements or degradations over time, and guide positions may be adjusted to provide further instruction or training as necessary.

### RELATED APPLICATIONS

This application claims the benefit of and priority to U.S. Provisional Application No. 63/024,330, entitled “Systems and Methods for Augmented Reality-Based Interactive Physical Therapy,” filed May 13, 2020, the entirety of which is incorporated by reference herein.

### FIELD OF THE DISCLOSURE

This disclosure generally relates to systems and methods for augmented reality-based physical therapy or training, and tracking and aggregation of position and pose data over time.

### BACKGROUND OF THE DISCLOSURE

Typical physical therapy or fitness training may require close interaction of physicians or trainers and patients or clients, with frequent monitoring of performance and capabilities to correct improper motions, address limitations, or otherwise correct imbalances. However, as therapy or training typically involves exercises or motions performed over extended time periods, such as days or weeks, the physician or trainer cannot always be present to monitor the client. Home exercises, though crucial to training or healing, may not always be performed accurately, which may degrade performance or create further imbalances.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is an illustration depicting an implementation of joint and component tracking of a user;

FIG. 1B is an illustration of an implementation of a view through an augmented reality system with interactive guide positions;

FIG. 1C is an illustration of an implementation of a guide position of FIG. 1B;

FIGS. 1D and 1E are illustrations of an implementation of body tracking measurements recorded via an interactive tracking system;

FIG. 2 is a block diagram of an implementation of a body tracking and augmented reality system;

FIG. 3 is a flow chart of an implementation of a method for body tracking and providing interactive positioning instruction;

FIG. 4A is a block diagram depicting an embodiment of a network environment including one or more access points in communication with one or more devices or stations; and

FIGS. 4B and 4C are block diagrams depicting embodiments of computing devices useful in connection with the methods and systems described herein.

The details of various embodiments of the methods and systems are set forth in the accompanying drawings and the description below.

### DETAILED DESCRIPTION

Typical physical therapy or fitness training may require close interaction of physicians or trainers and patients or clients, with frequent monitoring of performance and capabilities to correct improper motions, address limitations, or otherwise correct imbalances. However, as therapy or training typically involves exercises or motions performed over extended time periods, such as days or weeks, the physician or trainer cannot always be present to monitor the client. Home exercises, though crucial to training or healing, may not always be performed accurately, which may degrade performance or create further imbalances.

The implementations of body tracking systems and augmented reality interfaces discussed herein allow for mixing of the real world with rendered images or video in an intuitive and easy to use manner for clients. The combined system provides an augmented reality application that enables the user to accurately perform physical therapy or training exercises at home and enable real time monitoring and communication between the user and a remote physician or trainer, Using motion tracking capabilities of depth cameras and/or multiple camera setups, the system can create a real time three dimensional model that mirrors or guides the patient's movements and can show the patient how to properly perform an exercise with dynamic interactive feedback. The tracking capabilities further provide physicians or trainers with detailed measurements, both static and dynamic as well as tracking improvements or degradations over time, enabling insight not possible in discrete visits or interactions. Video and static images may be recorded and analyzed to track performance over time, and guide positions may be adjusted to provide further instruction or training as necessary.

The systems and methods discussed herein provide an intuitive and fun therapy or training in a real-time interactive manner previously unavailable with conventional static images of poses or video instruction. This helps users trying to do physical therapy or training from home reduce the risk of injury as well as increase the chances of successful treatment. Due to the enhanced user experience and corresponding user engagement with training or therapy, the user may recover from injuries or impairments faster and at lower expense than with traditional therapy or training systems.

Additionally, these systems and methods provide enhanced data and analysis capabilities for physical therapists and medical providers by enabling new ways of interacting with the patient. Real time communication and feedback may be provided remotely, avoiding the time and expense of in-person or in-office treatments, and the system may enable real time measurement, tracking over time, and comments and communication between patient and provider to also allow the therapist to suggest corrections and or make changes to the amount of repetitions or exercise being performed.

For purposes of reading the description of the various embodiments below, the following descriptions of the sections of the specification and their respective contents may be helpful:
Section A describes embodiments of systems and methods for augmented reality-based interactive physical therapy or training; and
Section B describes a network environment and computing environment which may be useful for practicing embodiments described herein.

### A. Systems and Methods for Augmented Reality-Based Interactive Physical Therapy or Training

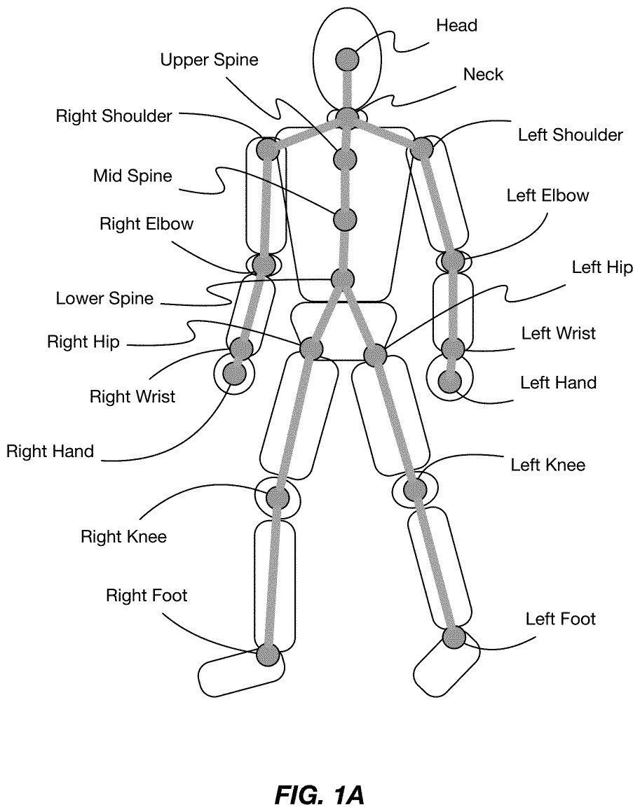

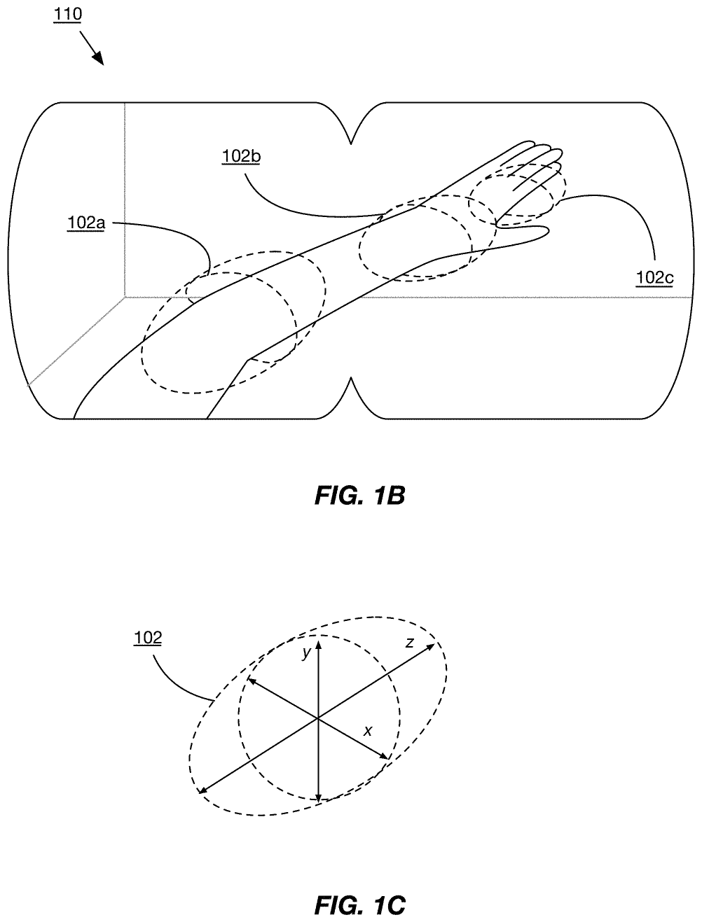

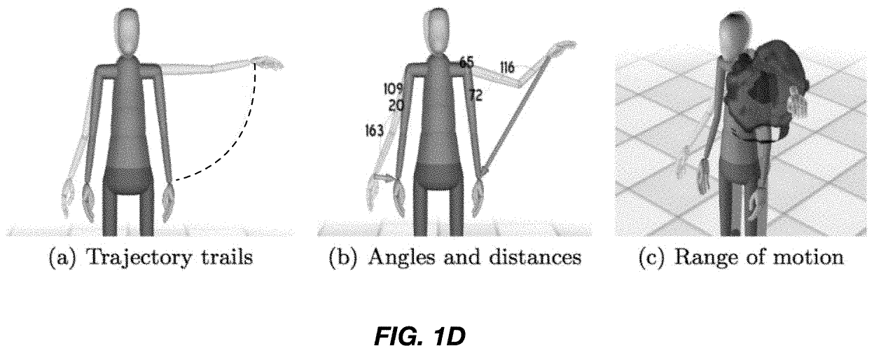

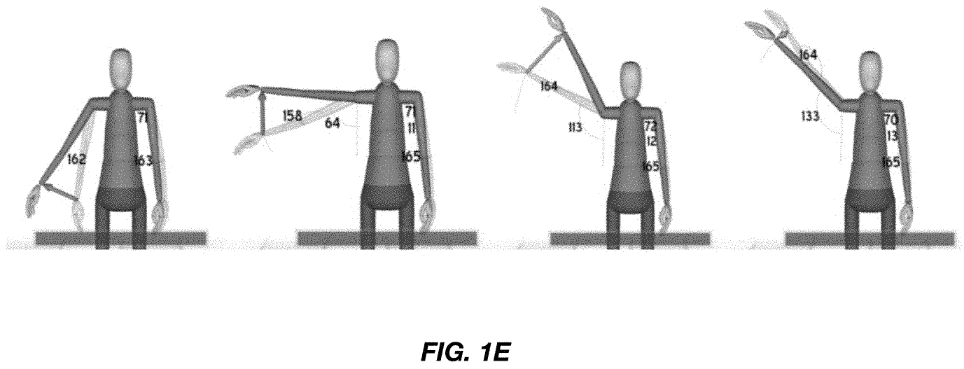

For physical therapy or raining exercises precision and accuracy are critical components to getting correct treatment. Depth cameras, sometimes referred to as time-of-flight cameras utilizing an infrared light, array of dots, or grid and sensor, may be used to measure depth to objects at which the camera is pointed, and may provide a depth map of an object or person. For example, the Kinect camera manufactured by Microsoft Corporation of Redmond, Wash. utilizes an infrared grid provided in pulses and a sensor to measure depth via reflection time to points at each intersection of the grid. With the help of machine learning, the Kinect or similar depth cameras can detect up to 25 “joints” in humans to provide a skeleton like structure and map movement from a range of 0.5-4.5 m. For example, referring briefly to FIG. 1A, illustrated is an implementation of a figure with components and joints that may be tracked to determine position and angles of each component and joint. Single-source depth cameras may suffer from occlusion in some implementations, and be unable to track components or joints when shadowed by other objects or body parts (e.g. a hand behind the user's back). In some implementations, stereoscopic cameras or camera arrays (including multiple depth cameras, in some implementations) may be used to determine depth to an object via triangulation. If the cameras are spaced widely enough apart (e.g. on orthogonal sides of the user, or even surrounding the user), occlusion may be avoided, improving tracking. In some implementations, tracking systems may allow for highly detailed tracking of body parts including individual fingers, and with accuracies of joint angles in three dimensions within 10 degrees, 5 degrees, 1 degree or less, depending on capabilities and number of cameras.

Once tracking of the user's joints and body components is available, the positions may be compared to guide positions or regions for exercises determined or set by a therapist or other user. For example, a user may be instructed to enter a given pose or position, and the cameras may be used to track the user's joints and body components to determine whether the user has properly entered the position. To provide dynamic feedback, in some implementations, an augmented reality display may be worn by the user and utilized to render one or more guide positions of the user's joints. Augmented reality displays provide rendered images or video overlaid on real world images, either directly viewed (e.g. through semi-transparent displays or glass against which a rendered image is presented) or indirectly viewed (e.g. through low-latency front-facing stereoscopic cameras on a virtual reality headset that approximately correspond to the user's eyes). For example, the HoloLens augmented reality system provided by Microsoft Corp. may be used to view the real world along with rendered images or video overlaid on the real image. Some implementations of augmented reality systems also incorporate additional cameras, depth cameras, sensors, or emitters that may be used to determine head positioning or viewing angles of the user (e.g. via “inside-out” head tracking based on analysis of images from the cameras, or “outside-in” head tracking in conjunction with an external camera recognizing positions of predetermined dots or lights on the headset). For example, the HoloLens system is equipped with a variety of sensors to aid the creation of a mixed reality environment: 4 environment understanding cameras, 1 depth camera, mixed reality capture, 4 microphones and 1 ambient light sensor. Using its many sensors the HoloLens can detect and understand spatial sound, gaze tracking, gesture input and voice input from users. These cameras may also provide for fine detail recognition of finger positions, in some implementations. In some implementations, multiple cameras of the same or different type may be utilized, such as a time of flight (TOF) camera and stereoscopic cameras (e.g. as a 3-camera system), with the TOF and three-dimensional camera views stitched together for better tracking (e.g. by detecting joints within each image and translating/scaling as necessary to align the joints). In other implementations, a greater or fewer number of cameras may be used, with images similarly stitched together.

Referring to FIG. 1B, illustrated is an implementation of a view through an augmented reality system with interactive guide positions 102a-102c. The view may be provided via stereoscopic displays or viewed directly via a semi-transparent display or lens, as discussed above, such that the user may view the surrounding environment and their own body. To provide instruction for a pose, the system may render one or more guide positions 102a-102c, referred to generally as guide positions 102, “bubbles”, or by similar terms, with each guide position corresponding to a user's joint and/or body part. Although shown with a dashed boundary, in many implementations the guide positions 102 may be displayed as semi-transparent or translucent regions, bubbles, or clouds in three-dimensional space relative to the user, and may frequently comprise ellipsoids, spheres, or similar shapes. A plurality of such guide positions, with each corresponding to a joint or body part, may be referred to as a virtual “bubble man” or “bubble woman” and may serve as an interactive and dynamic three dimensional guide to a position for the user to assume. For example, in some implementations, once a user's body components are tracked by the cameras, the virtual bubble man may be superimposed over the user (with each guide bubble “attaching” to the user's own joints). The guide positions may then be dynamically moved in three dimensions along a predetermined path, with the user instructed to move their limbs to keep their joints within the corresponding guide positions. Successful and unsuccessful positioning through the movement may be scored and analyzed, as discussed in more detail below.

The user may move their body part into the corresponding position through the virtual and translucent guide position shape, and the tracking system may determine when a tracked joint or body component is within the corresponding three dimensional region corresponding to the guide position shape. For example, in FIG. 1B, the user's left arm is positioned with their elbow within ellipsoid 102a and their wrist within ellipsoid 102b. Their hand is slightly out of position relative to ellipsoid 102c, and the system may detect the improper angle and position of the hand and provide dynamic feedback (e.g. lighting up regions in one color such as green when the user is properly positioned and in a second color such as red when the user is improperly positioned, or by playing a tone or buzzer when incorrectly positioned). The user may be required to hold positions for a predetermined time or may be required to move a joint or body component through a range along with a corresponding moving guide position or positions 102. Referring briefly to the illustration of a guide position 102 in FIG. 1C, in some implementations, the dimensions of each guide position 102 may be dynamically adjusted (e.g. x, y, and z diameters of the ellipsoid), for example narrowing the dimensions as the user becomes more proficient or capable of matching positions. Other shapes may also be utilized in some implementations. The dimensions, positions, and movements may be configured by a therapist based on the different mobility and physical activity levels of the user, providing therapeutic flexibility as treatment progresses.

Additionally, in some implementations, the augmented reality environment may be used to provide additional images or video to enhance exercises. For example, virtual objects may be displayed in the three dimensional space to encourage the user to perform predetermined exercises, such as picking virtual apples or interacting with virtual objects to perform a given task. Breaking the monotonous tasks involved in physical therapy or training exercises will help the patient be motivated to continue treatment and further develop their skills. The system may monitor the correct number of repetitions or time spent performing the task, and may correct the patient's form in real time via dynamic feedback as discussed above if they are doing something incorrectly. Specifics may vary by the activity being done and the environment designed for that activity. The augmented reality system may also be used to provide interactive menus or other user interface elements (for example, selectable by looking at a desired item on a virtual menu or reaching out to “press” a virtual button), allowing the user to select desired activities or exercises.

The body tracking system may also be used to record detailed measurements of the user's movement. Feedback tools including trajectory measurements, joint angle measurements, distance to target (e.g. distance between position guide objects and corresponding body component or joint objects), and range of motion per exercise measurements can be dynamically activated or deactivated on a joint-by-joint or component by component basis, such that any joint or component can be tracked and monitored for analysis by a therapist, either in real time or via recorded playback. For example, referring to FIG. 1D, the tracking system may be used to measure joint angles in three dimensions (e.g. angles between adjacent body parts linked by a joint) as well as distances travelled by a joint or body component. In some implementations, the augmented reality display may be used to display measurements in the virtual environment or trajectory trails (e.g. rendering multiple successive frames simultaneously, with earlier frames at partial transparency or increasing transparency over time, such that only a few frames are visible so as to display a trail) showing the movement of a joint over time (e.g. during a movement). In some implementations, multiple measurements may be combined to determine a range of motion of a joint (e.g. to determine a lack of flexibility in a particular direction). In a further such implementation, the range of motion may be displayed within the virtual environment (e.g. as a three dimensional heat map or cloud covering angles through which the joint is rotated or moved). Similarly, FIG. 1E illustrates a plurality of measurements that may be recorded during motions and displayed, either dynamically to the user during movement, or to a therapist remotely (either live or during subsequent playback of a historical log of movements of the patient). In some implementations, measurements may be aggregated to determine a maximum range of motion (for example, if a user lifts their arm by 45 degrees and then subsequently by 60 degrees, in some implementations, only the maximum angle may be displayed).

Trajectory trails of selected joints can be displayed in real time, within the augmented reality environment or on a separate display, showing the performed trajectory of a joint during a fixed period of time or after a user's performance, showing the performed trajectory compliance range with the reference exercise. This visualization is based on fine polygonal segments sampled per frame for precise analysis or generated smoothly by B-spline interpolation. A virtual goniometer is used for angle estimation where joint angles can be visualized with lines pinpointing the angle value. The provided angle measurements may be compared to the angles measured in the patient's exercises to ensure proper exercise execution. By using the virtual goniometer, the system may measure any angle by defining specified pairs of joints and a reference frame. In some implementations, colored 3D arrows may be used to show the distance between corresponding angles which track compliance with the demonstrated exercises. The arrows may be programmed to automatically disappear if the distance is under a given threshold, providing negative feedback for non-performance or non-compliance with the exercise. The range of motion visualization analyzes the rotation of a selected joint over time (e.g. during an exercise or across multiple exercises). The boundary of a colored map or heat map may represent the range of motion executed in each exercise using a Gaussian distribution centered on the joint. This helps log improvement and observing the patient's ability to perform precise trajectories or determining if a range of motion causes them discomfort.

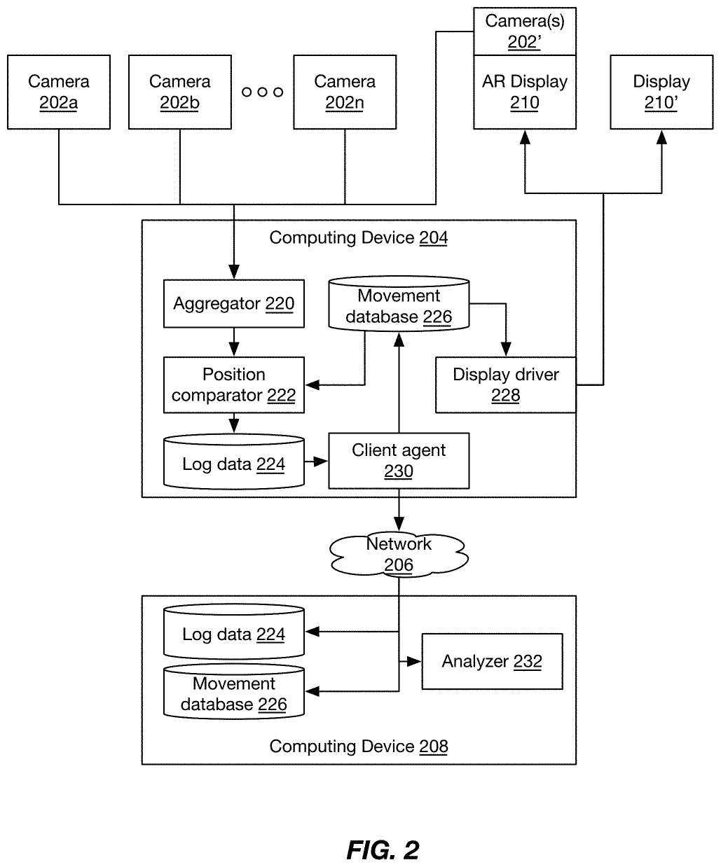

FIG. 2 is a block diagram of an implementation of a body tracking and augmented reality system. The system may include a first computing device 204 (e.g. of a user or client) in communication via a network 206 with a second computing device 208 (e.g. of a therapist or provider). The first computing device 204 and second computing device 208 may each comprise any type and form of computing device, including a desktop computer, laptop computer, video game console, tablet computer, smart television, or other such device having sufficient video processing capability (e.g. processing power to aggregate images from cameras, detect body positions of a user, render guide positions in a virtual environment, and/or perform tracking measurements). Each computing device 204 and 208 may comprise one or more processors or CPUs, one or more graphics processors or GPUs, one or more network interfaces, one or more memory devices storing applications and log data, one or more input/output devices or interfaces, and/or any other such components. Network 206 may comprise any type and form of network, such as a Wide Area Network (WAN, such as the Internet), a local area network (LAN), a wired network (e.g. Ethernet), a wireless network such as an 802.11 (WiFi) network, a cellular network, or a satellite network, a broadband network, or any other type and form or combination of networks. Network 206 may include one or more additional devices not illustrated such as firewalls, switches, access points, or other devices.

Computing device 204 may record images or data from one or more cameras 202a-202n, which may comprise infrared emitters and time-of-flight depth cameras, RGB or black and white cameras such as stereoscopic cameras, LIDAR sensors, or any other type and form of camera or optical sensor, such as a Microsoft Kinect or Orbbec Astra 3D camera. In some implementations, cameras 202 may be deployed to capture three dimensional positions of a user's body, such as on opposing sides of the user or surrounding the user. In other implementations, one or more positions may be occluded from the cameras 202. In some such implementations, the occluded positions may be estimated from previously known positions (e.g. with a priori knowledge of the length of a user's limb or body component between adjacent joints, measured from a previous non-occluded view, for example).

In many implementations, computing device 204 may provide images to an augmented reality display 210 or other display 210′. Augmented reality display 210 may comprise an AR headset or glasses, a virtual reality headset with integrated stereoscopic “view-through” cameras 202′, or any similar components for displaying a virtual environment or virtual objects or guide positions superimposed on a real view of the user's body.

Computing device 204 may comprise an aggregator 220, which may comprise an application, service, server, daemon, routine, or other executable logic for combining images and/or depth data from cameras 202, 202′ and determining positions of a user's joints and body components. Aggregator 220 may be embodied in software, hardware (e.g. an ASIC or FPGA) or a combination of hardware and software. Aggregator 220 may comprise a skeletal tracking application for processing depth maps of a user and determining joint and limb positions, such as the Kinect software development kit (SDK) provided by Microsoft Corp. or any equivalent. In some implementations, aggregator 220 may comprise a machine learning system, such as a trained neural network for processing images from cameras 202, 202′ and determining joint and limb positions. In some such implementations, aggregator 220 may comprise a tensor processing unit (TPU) or similar co-processing hardware for faster aggregation and analysis of skeletal positions.

Computing device 204 may comprise a position comparator 222, which may comprise an application, service, server, daemon, routine, or other executable logic for comparing determined positions of a user's joints and/or body components to static or dynamic guide regions, which may be moved according to poses or movements identified in a movement database 226. In one such implementation, position comparator may comprise a collision detector. Small objects, such as spheres or ellipsoids, may be positioned in a virtual three dimensional environment according to positions of the user's joints and/or body components determined by the aggregator 220. Larger spheres or ellipsoids corresponding to guide positions may be positioned in the virtual three dimensional environment (in some implementations initially positioned in the same locations as the corresponding joint or body component objects, to “lock” the bubble man to the user's position). The guide position ellipsoids or spheres may be dynamically moved (e.g. along recorded or specified paths according to an exercise defined in the movement database 226), and collisions between each guide position object and the corresponding joint or body component object may be detected. The absence of a collision may indicate that the user's joint is no longer within the guide position region, and feedback may be provided to the user as discussed above. Distances and angles between the center of each guide position object and the center of the corresponding joint or body component object may be determined (e.g. as vectors) to measure an accuracy of positioning within the region. A duration of correct or incorrect placement may be recorded and/or a counter may be incremented for correct or incorrect placement during a movement or exercise, in some implementations. In some implementations, a score may be determined (e.g. inversely proportional to the length of the positioning vector, in some implementations) to provide further feedback for the user or therapist.

Three dimensional positions of each of the user's joints and/or body components may be recorded during each exercise or motion based on the tracking data, and recorded in a log 224 and stored on a memory device of the computing device 204. In some implementations, video from or more cameras may also be recorded in the log 224 for subsequent analysis, transfer to a second computing device 208 and/or playback (e.g. for a therapist).

As discussed above, dimensions, positions, and/or paths of guide position objects may be configured by a user or medical provider and may be stored in a movement database 226 in a memory device of the computing device 204. Paths may be stored as a series of positions and corresponding times, as vectors and velocities, or in any other suitable manner. Movement database 226 may also store exercises, poses, games, or activities to be performed by the user, and may thus include executable logic for gameplay or other interactive exercises, as well as data for other associated components (e.g. virtual objects, textures, or other data).

Computing device 204 may also comprise a display driver 228, which may comprise an application, service, server, daemon, routine, or other executable logic for rendering objects in a three-dimensional virtual environment via an augmented reality or virtual reality display 210 and/or other displays 210′. For example, in some implementations, display driver 228 may include a virtual environment development platform, such as the Unity SDK provided by Unity Technologies of San Francisco, Calif., and may include functionality for displaying or rendering objects in a three dimensional environment. In some implementations, the virtual environment development platform may also include the position comparator 222, and thus these components may be combined. The virtual environment may be used to display guide regions or bubbles, as well as other virtual objects, including trajectory trails of joints, angle or distance measurements, virtual user interfaces or menus, or other interactive components.

Computing device 204 may also execute a client agent 230. Client agent 230 may comprise an application, service, server, daemon, routine, or other executable logic for instantiating or configuring aggregator 220, position comparator 222, and/or display driver 228. Client agent 230 may also comprise a communication application for sending log data or videos 224 via a network 206 to a remote computing device 208 and/or for retrieving position or movement data for a movement database 226 from a remote computing device 208. In some implementations, client agent 230 may establish a real time communication session with a remote computing device to provide a therapist with real time dynamic monitoring of a user's body tracking data and/or videos (e.g. via a UDP connection to a server, etc.). In some such implementations, client agent 230 may perform various handshaking or authentication procedures, and may provide encryption for data to ensure user privacy.

A remote computing device 208 of a therapist or physician may retrieve or receive log data 224 from one or more client computing devices 204 as well as providing movements or exercise data for a movement database 226. Computing device 208 may comprise an analyzer 232, which may comprise an application, service, server, daemon, routine, or other executable logic for configuring position guides and movements for exercises and/or for analyzing log data of clients. Analyzer 232 may analyze joint and/or body component tracking information from client devices to determine joint angles, ranges or fields of motion, distances of travel, or other such information. Analyzer 232 may render measurements via a display (not illustrated), as discussed above in connection with FIGS. 1D and 1E, in some implementations. Analyzer 232 may also compare measurements to past measurements or historical log data 224 to determine whether angles or ranges of motion have increased or decreased, or detect improvement or degradation of impairments. Although shown on remote computing device 208, in many implementations, client agent 230 of a computing device 204 may execute an analyzer 232 or an analyzer may be separately executed by a processor of client computing device 204.

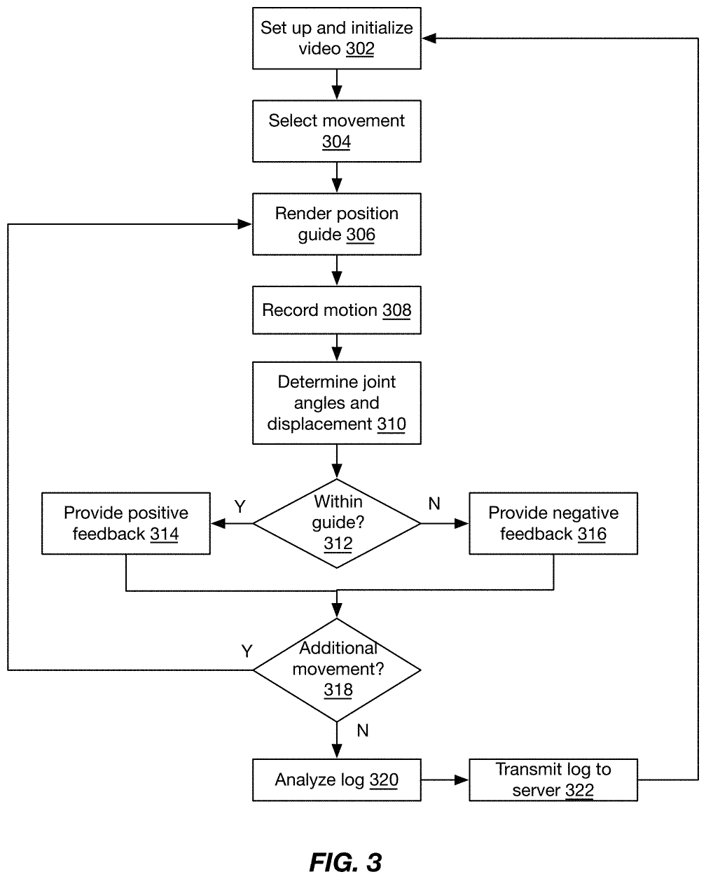

FIG. 3 is a flow chart of an implementation of a method for body tracking and providing interactive positioning instruction. At step 302, the system may be initialized and an initial body position of a user within a three dimensional environment determined via one or more cameras or depth sensors. In some implementations, a plurality of guide positions or bubbles may be overlaid on the positions of corresponding joints and/or body components of a user within the three dimensional environment and rendered via a display, such as an augmented reality display. In some implementations, smaller additional objects may be generated for each joint or body component and similarly positioned in the three dimensional environment, such that collisions (or lack of collisions) between the additional objects and the guide position objects may be detected to determine if the user is in proper positioning.

At step 304, a movement or exercise may be selected. The movement or exercise may comprise positions for one or more guide objects, or paths and velocities for moving the one or more guide objects over time. The positions, paths, and velocities may be configured by a therapist, and may include one or more complex paths or combinations of paths, positions, and durations (e.g. raise left arm to 90 degrees; hold for 5 seconds; then rotate arm to front by 90 degrees over 10 seconds; etc.).

At step 306, the position guides may be rendered within the virtual three dimensional environment for display by the augmented reality display according to the movement positions or paths. At step 308, the positions of the user's joints and/or body components may be recorded, and at step 310 in some implementations, the angles and displacement of each joint and body component may be measured relative to a previous position.

At step 312, the system may determine whether each joint and/or body component is within a corresponding guide position. As discussed above, this may comprise detecting a collision or absence of collision between the guide position object and the object associated with the corresponding user's joint or body component. In some implementations, a difference in position between the guide position object and the object associated with the corresponding user's joint or body component may be determined (e.g. as a vector). In some implementations, a position score may be determined (e.g. inversely proportional to the length of the difference vector). If a collision is detected or if the user's joint or body component is within the corresponding guide position region, then at step 314, positive feedback may be provided (e.g. sounding a tone, changing a color of the guide position object, etc.). Conversely, if no collision is detected or if the user's joint or body component is not within the corresponding guide position region, then at step 316, negative feedback may be provided (e.g. sounding a different tone, changing a color of the guide position object, etc.). Steps 310-316 may be repeated for each additional joint and/or body component and corresponding guide position.

At step 318, the system may determine whether additional movements or positions are included in the selected exercise. If so, then steps 306-318 may be repeated.

In some implementations, once the movement is complete, a recording or log of the user's movements, scores, collision detection results, difference vectors, or other such measurements may be generated and provided for analysis. In some implementations, the log data may be transmitted to another computing device for subsequent analysis, while in other implementations, the log data may be analyzed locally at step 320 and the results provided to another computing device at step 322. Analysis may comprise measuring joint angles or ranges of motion, displacement ranges, proper placement counters or scores, or other such data, as well as comparing the measurements to past measurements from previous exercises or log data (e.g. to determine changes in functionality over time).

In some implementations, the user or a therapist can customize exercises and record a demonstration (e.g. to specify positions or movements for guide positions by assuming the corresponding positions or poses by the therapist), which may be provided to users for viewing. The presented exercises may be demonstrated via modeling and correction mechanisms that provide parameterization for real-time adaption and produce continuous motions that adapt to user responses. A constraint mechanism may be used to help correct noise in the motion, inform of motion parameterization and provide metrics for quantifying motion compliance. The metrics provide visual feedback for the user informing the correctness of motion reproduction and enhance user performance score for each session. Real time adaptation mechanisms are also used to collect information about the patient's performance in real time in order to adapt the current exercise in its next repetition. The system tracks the difference or distance between the user's end-effector and the point at the target amplitude position (e.g. the length and/or direction or angle of the position guide's path). If the tracked distance is larger than the amplitude compliance parameter specified by the therapist, the next exercise execution may lower the target amplitude to a position attainable by the user. In some implementations, as discussed above, the user may be instructed to hold a position for a duration; durations may be tracked and increased or decreased dynamically based on compliance to make the exercise more or less difficult (e.g., if the patient is having difficulty in maintaining a hold time, the next exercise hold time will be reduced until the user is able to maintain posture and duration). Wait time between exercises may also be monitored and changed due to the user's performance (e.g. increased if the user is unable to perform the exercise properly, decreased if the user is able to do so, etc.).

Accordingly, the systems and methods discussed herein provide body tracking systems and augmented reality interfaces. These systems provide an augmented reality application that enables a user to accurately perform physical therapy or training exercises at home and enable real time monitoring and communication between the user and a remote physician or trainer. Using motion tracking capabilities of depth cameras and/or multiple camera setups, the system can create a real time three dimensional model that mirrors or guides the patient's movements and can show the patient how to properly perform an exercise with dynamic interactive feedback. The tracking capabilities further provide physicians with detailed measurements as well as tracking improvements or degradations over time, and guide positions may be adjusted to provide further instruction or training as necessary.

In some aspects, the present disclosure is directed to a method for physical interaction with augmented reality environments. The method includes rendering, within a virtual environment via a display of a computing system, a position guide at a first position, the position guide corresponding to a portion of a user's body. The method also includes capturing, by a camera of the computing system, an image of the corresponding portion of the user's body at a second position. The method also includes rendering, within the virtual environment via the display, the captured image at the second position. The method also includes determining, by the computing system, a difference between the first position and the second position. The method also includes rendering, within the virtual environment via the display, an indication responsive to the determined difference exceeding a threshold.

In some implementations, the display comprises an augmented reality stereoscopic display, and capturing the image of the corresponding portion of the user's body at the second position and rendering the captured image at the second position are performed essentially simultaneously. In some implementations, the position guide comprises a three-dimensional region within the virtual environment.

In some implementations, capturing the image of the corresponding portion of the user's body further comprises capturing a stereoscopic image, via a stereoscopic camera of the computing system. In some implementations, the method includes detecting a joint within the portion of the user's body in the captured image. In a further implementation, the method includes determining an angle or displacement of the detected joint relative to a second joint.

In some implementations, the method includes rendering, within the virtual environment via the display, the position guide at each of a first plurality of positions during a first time period; capturing, by the camera, a plurality of images of the corresponding portion of the user's body at each of a second plurality of positions during the first time period; and rendering, within the virtual environment via the display, the captured plurality of images during the first time period. In a further implementation, the method includes determining, by the computing system, a difference between each position of the first plurality of positions and a corresponding position of the second plurality of positions; and rendering, within the virtual environment for each position and corresponding position of the first and second plurality of positions, an indication responsive to the determined difference exceeding a threshold. In another further implementation, the method includes rendering a subset of the captured plurality of images simultaneously for at least one rendered frame of the first time period.

In some implementations, the method includes comparing the determined difference between the first position and the second position to a historical log of differences between the first position and additional positions of the corresponding portion of the user's body captured in additional images; and providing a notification to a second computing system, responsive to determining that a trend of the differences exceeds a threshold.

In another aspect, the present disclosure is directed to a system for physical interaction with augmented reality environments. The system includes a computing system comprising a processor, at least one camera, and at least one display. The processor is configured to: render, via the display within a virtual environment, a position guide at a first position, the position guide corresponding to a portion of a user's body; capture, via the camera, an image of the corresponding portion of the user's body at a second position; render, within the virtual environment via the display, the captured image at the second position; determine a difference between the first position and the second position; and render, within the virtual environment via the display, an indication responsive to the determined difference exceeding a threshold.

In some implementations, the display comprises an augmented reality stereoscopic display, and the processor is further configured to capture the image of the corresponding portion of the user's body at the second position and render the captured image at the second position essentially simultaneously. In some implementations, the position guide comprises a three-dimensional region within the virtual environment. In some implementations, the at least one camera comprises a stereoscopic camera. In some implementations, the processor is further configured to detect a joint within the portion of the user's body in the captured image. In a further implementation, the processor is further configured to determine an angle or displacement of the detected joint relative to a second joint.

In some implementations, the processor is further configured to: render, within the virtual environment via the display, the position guide at each of a first plurality of positions during a first time period; capture, via the camera, a plurality of images of the corresponding portion of the user's body at each of a second plurality of positions during the first time period; and render, within the virtual environment via the display, the captured plurality of images during the first time period. In a further implementation, the processor is further configured to: determine a difference between each position of the first plurality of positions and a corresponding position of the second plurality of positions; and render, within the virtual environment for each position and corresponding position of the first and second plurality of positions, an indication responsive to the determined difference exceeding a threshold. In another further implementation, the processor is further configured to render a subset of the captured plurality of images simultaneously for at least one rendered frame of the first time period.

In some implementations, the processor is further configured to compare the determined difference between the first position and the second position to a historical log of differences between the first position and additional positions of the corresponding portion of the user's body captured in additional images; and provide a notification to a second computing system, responsive to determining that a trend of the differences exceeds a threshold.

### B. Computing and Network Environment

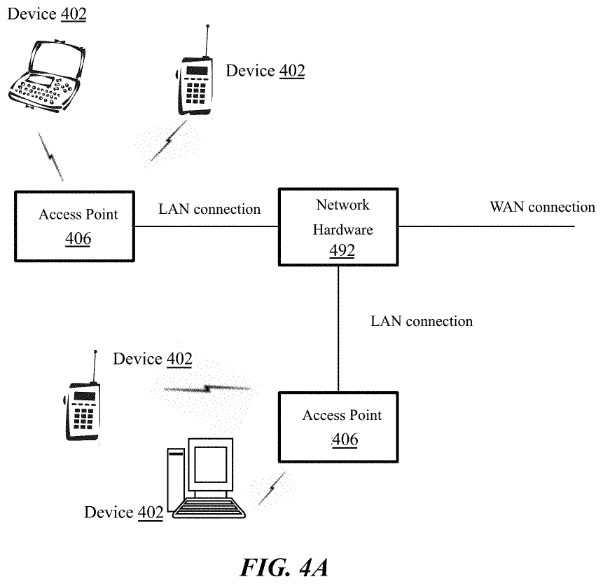

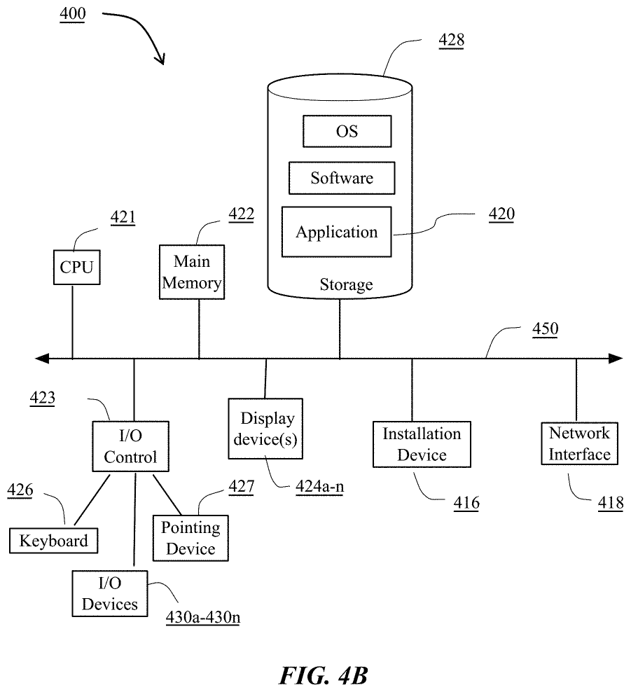

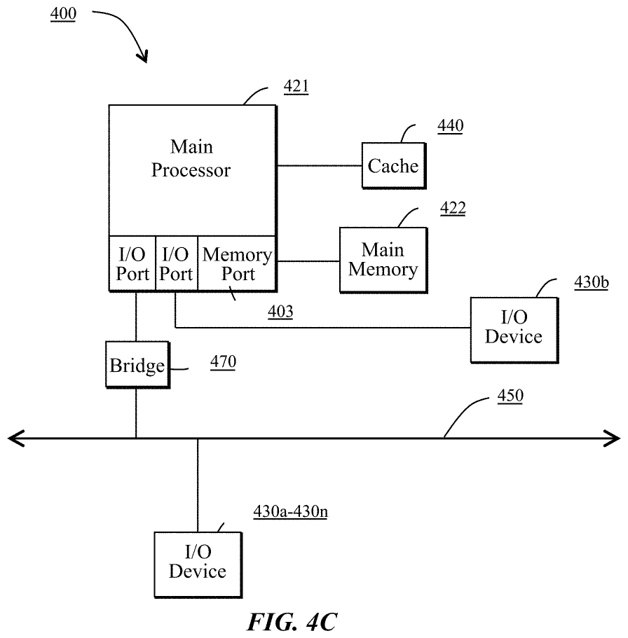

Having discussed specific embodiments of the present solution, it may be helpful to describe aspects of the operating environment as well as associated system components (e.g., hardware elements) in connection with the methods and systems described herein. Referring to FIG. 4A, an embodiment of a network environment is depicted. In brief overview, the network environment includes a wireless communication system that includes one or more access points 406, one or more wireless communication devices 402 and a network hardware component 492. The wireless communication devices 402 may for example include laptop computers 402, tablets 402, personal computers 402 and/or cellular telephone devices 402. The details of an embodiment of each wireless communication device and/or access point are described in greater detail with reference to FIGS. 4B and 4C. The network environment can be an ad hoc network environment, an infrastructure wireless network environment, a subnet environment, etc. in one embodiment

The access points (APs) 406 may be operably coupled to the network hardware 492 via local area network connections. The network hardware 492, which may include a router, gateway, switch, bridge, modem, system controller, appliance, etc., may provide a local area network connection for the communication system. Each of the access points 406 may have an associated antenna or an antenna array to communicate with the wireless communication devices 402 in its area. The wireless communication devices 402 may register with a particular access point 406 to receive services from the communication system (e.g., via a SU-MIMO or MU-MIMO configuration). For direct connections (e.g., point-to-point communications), some wireless communication devices 402 may communicate directly via an allocated channel and communications protocol. Some of the wireless communication devices 402 may be mobile or relatively static with respect to the access point 406.

In some embodiments an access point 406 includes a device or module (including a combination of hardware and software) that allows wireless communication devices 402 to connect to a wired network using Wi-Fi, or other standards. An access point 406 may sometimes be referred to as an wireless access point (WAP). An access point 406 may be configured, designed and/or built for operating in a wireless local area network (WLAN). An access point 406 may connect to a router (e.g., via a wired network) as a standalone device in some embodiments. In other embodiments, an access point can be a component of a router. An access point 406 can provide multiple devices 402 access to a network. An access point 406 may, for example, connect to a wired Ethernet connection and provide wireless connections using radio frequency links for other devices 402 to utilize that wired connection. An access point 406 may be built and/or configured to support a standard for sending and receiving data using one or more radio frequencies. Those standards, and the frequencies they use may be defined by the IEEE (e.g., IEEE 802.11 standards). An access point may be configured and/or used to support public Internet hotspots, and/or on an internal network to extend the network's Wi-Fi signal range.

In some embodiments, the access points 406 may be used for (e.g., in-home or in-building) wireless networks (e.g., IEEE 802.11, Bluetooth, ZigBee, any other type of radio frequency based network protocol and/or variations thereof). Each of the wireless communication devices 402 may include a built-in radio and/or is coupled to a radio. Such wireless communication devices 402 and/or access points 406 may operate in accordance with the various aspects of the disclosure as presented herein to enhance performance, reduce costs and/or size, and/or enhance broadband applications. Each wireless communication devices 402 may have the capacity to function as a client node seeking access to resources (e.g., data, and connection to networked nodes such as servers) via one or more access points 406.

The network connections may include any type and/or form of network and may include any of the following: a point-to-point network, a broadcast network, a telecommunications network, a data communication network, a computer network. The topology of the network may be a bus, star, or ring network topology. The network may be of any such network topology as known to those ordinarily skilled in the art capable of supporting the operations described herein. In some embodiments, different types of data may be transmitted via different protocols. In other embodiments, the same types of data may be transmitted via different protocols.

The communications device(s) 402 and access point(s) 406 may be deployed as and/or executed on any type and form of computing device, such as a computer, network device or appliance capable of communicating on any type and form of network and performing the operations described herein. FIGS. 4B and 4C depict block diagrams of a computing device 400 useful for practicing an embodiment of the wireless communication devices 402 or the access point 406. As shown in FIGS. 4B and 4C, each computing device 400 includes a central processing unit 421, and a main memory unit 422. As shown in FIG. 4B, a computing device 400 may include a storage device 428, an installation device 416, a network interface 418, an I/O controller 423, display devices 424a-424n, a keyboard 426 and a pointing device 427, such as a mouse. The storage device 428 may include, without limitation, an operating system and/or software. As shown in FIG. 4C, each computing device 400 may also include additional optional elements, such as a memory port 403, a bridge 470, one or more input/output devices 430a-430n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 400 may be based on any of these processors, or any other processor capable of operating as described herein.

Main memory unit 422 may be one or more memory chips capable of storing data and allowing any storage location to be directly accessed by the microprocessor 421, such as any type or variant of Static random access memory (SRAM), Dynamic random access memory (DRAM), Ferroelectric RAM (FRAM), NAND Flash, NOR Flash and Solid State Drives (SSD). The main memory 422 may be based on any of the above described memory chips, or any other available memory chips capable of operating as described herein. In the embodiment shown in FIG. 4B, the processor 421 communicates with main memory 422 via a system bus 450 (described in more detail below). FIG. 4C depicts an embodiment of a computing device 400 in which the processor communicates directly with main memory 422 via a memory port 403. For example, in FIG. 4C the main memory 422 may be DRDRAM.

FIG. 4C depicts an embodiment in which the main processor 421 communicates directly with cache memory 440 via a secondary bus, sometimes referred to as a backside bus. In other embodiments, the main processor 421 communicates with cache memory 440 using the system bus 450. Cache memory 440 typically has a faster response time than main memory 422 and is provided by, for example, SRAM, BSRAM, or EDRAM. In the embodiment shown in FIG. 4C, the processor 421 communicates with various I/O devices 430 via a local system bus 450. Various buses may be used to connect the central processing unit 421 to any of the I/O devices 430, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4C depicts an embodiment of a computer 400 in which the main processor 421 may communicate directly with I/O device 430b, for example via HYPERTRANSPORT, RAPIDIO, or INFINIBAND communications technology. FIG. 4C also depicts an embodiment in which local busses and direct communication are mixed: the processor 421 communicates with I/O device 430a using a local interconnect bus while communicating with I/O device 430b directly.

A wide variety of I/O devices 430a-430n may be present in the computing device 400. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 423 as shown in FIG. 4B. The I/O controller may control one or more I/O devices such as a keyboard 426 and a pointing device 427, e.g., a mouse or optical pen. Furthermore, an I/O device may also provide storage and/or an installation medium 416 for the computing device 400. In still other embodiments, the computing device 400 may provide USB connections (not shown) to receive handheld USB storage devices such as the USB Flash Drive line of devices manufactured by Twintech Industry, Inc. of Los Alamitos, Calif.

Referring again to FIG. 4B, the computing device 400 may support any suitable installation device 416, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 400 may further include a storage device, such as one or more hard disk drives or redundant arrays of independent disks, for storing an operating system and other related software, and for storing application software programs such as any program or software 420 for implementing (e.g., configured and/or designed for) the systems and methods described herein. Optionally, any of the installation devices 416 could also be used as the storage device. Additionally, the operating system and the software can be run from a bootable medium.

Furthermore, the computing device 400 may include a network interface 418 to interface to the network 404 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 400 communicates with other computing devices 400′ via any type and/or form of gateway or tunneling protocol such as Secure Socket Layer (SSL) or Transport Layer Security (TLS). The network interface 418 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

In some embodiments, the computing device 400 may include or be connected to one or more display devices 424a-424n. As such, any of the I/O devices 430a-430n and/or the I/O controller 423 may include any type and/or form of suitable hardware, software, or combination of hardware and software to support, enable or provide for the connection and use of the display device(s) 424a-424n by the computing device 400. For example, the computing device 400 may include any type and/or form of video adapter, video card, driver, and/or library to interface, communicate, connect or otherwise use the display device(s) 424a-424n. In one embodiment, a video adapter may include multiple connectors to interface to the display device(s) 424a-424n. In other embodiments, the computing device 400 may include multiple video adapters, with each video adapter connected to the display device(s) 424a-424n. In some embodiments, any portion of the operating system of the computing device 400 may be configured for using multiple displays 424a-424n. One ordinarily skilled in the art will recognize and appreciate the various ways and embodiments that a computing device 400 may be configured to have one or more display devices 424a-424n.

In further embodiments, an I/O device 430 may be a bridge between the system bus 450 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 400 of the sort depicted in FIGS. 4B and 4C may operate under the control of an operating system, which control scheduling of tasks and access to system resources. The computing device 400 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 400 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 400 has sufficient processor power and memory capacity to perform the operations described herein.

In some embodiments, the computing device 400 may have different processors, operating systems, and input devices consistent with the device. For example, in one embodiment, the computing device 400 is a smart phone, mobile device, tablet or personal digital assistant. In still other embodiments, the computing device 400 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 400 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

What is claimed:

1. A method for physical interaction with augmented reality environments, comprising:
rendering, within a virtual environment via a display of a computing system, a position guide at a first position, the position guide corresponding to a portion of a user's body;
capturing, by a camera of the computing system, an image of the corresponding portion of the user's body at a second position;
rendering, within the virtual environment via the display, the captured image at the second position;
determining, by the computing system, a difference between the first position and the second position;
rendering, within the virtual environment via the display, an indication responsive to the determined difference exceeding a threshold.

2. The method of claim 1, wherein the display comprises an augmented reality stereoscopic display, and wherein capturing the image of the corresponding portion of the user's body at the second position and rendering the captured image at the second position are performed essentially simultaneously.

3. The method of claim 1, wherein the position guide comprises a three-dimensional region within the virtual environment.

4. The method of claim 1, wherein capturing the image of the corresponding portion of the user's body further comprises capturing a stereoscopic image, via a stereoscopic camera of the computing system.

5. The method of claim 1, further comprising detecting a joint within the portion of the user's body in the captured image.

6. The method of claim 5, further comprising determining an angle or displacement of the detected joint relative to a second joint.

7. The method of claim 1, further comprising:
rendering, within the virtual environment via the display, the position guide at each of a first plurality of positions during a first time period;
capturing, by the camera, a plurality of images of the corresponding portion of the user's body at each of a second plurality of positions during the first time period; and
rendering, within the virtual environment via the display, the captured plurality of images during the first time period.

8. The method of claim 7, further comprising:
determining, by the computing system, a difference between each position of the first plurality of positions and a corresponding position of the second plurality of positions; and
rendering, within the virtual environment for each position and corresponding position of the first and second plurality of positions, an indication responsive to the determined difference exceeding a threshold.

9. The method of claim 7, wherein rendering the captured plurality of images during the first time period further comprises rendering a subset of the captured plurality of images simultaneously for at least one rendered frame of the first time period.

10. The method of claim 1, further comprising comparing the determined difference between the first position and the second position to a historical log of differences between the first position and additional positions of the corresponding portion of the user's body captured in additional images; and providing a notification to a second computing system, responsive to determining that a trend of the differences exceeds a threshold.

11. A system for physical interaction with augmented reality environments, comprising:
a computing system comprising a processor, at least one camera, and at least one display;
wherein the processor is configured to:
render, via the display within a virtual environment, a position guide at a first position, the position guide corresponding to a portion of a user's body;
capture, via the camera, an image of the corresponding portion of the user's body at a second position;
render, within the virtual environment via the display, the captured image at the second position;
determine a difference between the first position and the second position; and
render, within the virtual environment via the display, an indication responsive to the determined difference exceeding a threshold.

12. The system of claim 11, wherein the display comprises an augmented reality stereoscopic display, and wherein the processor is further configured to capture the image of the corresponding portion of the user's body at the second position and render the captured image at the second position essentially simultaneously.

13. The system of claim 11, wherein the position guide comprises a three-dimensional region within the virtual environment.

14. The system of claim 11, wherein the at least one camera comprises a stereoscopic camera.

15. The system of claim 11, wherein the processor is further configured to detect a joint within the portion of the user's body in the captured image.

16. The system of claim 15, wherein the processor is further configured to determine an angle or displacement of the detected joint relative to a second joint.

17. The system of claim 11, wherein the processor is further configured to:
render, within the virtual environment via the display, the position guide at each of a first plurality of positions during a first time period;
capture, via the camera, a plurality of images of the corresponding portion of the user's body at each of a second plurality of positions during the first time period; and
render, within the virtual environment via the display, the captured plurality of images during the first time period.

18. The system of claim 17, wherein the processor is further configured to:
determine a difference between each position of the first plurality of positions and a corresponding position of the second plurality of positions; and
render, within the virtual environment for each position and corresponding position of the first and second plurality of positions, an indication responsive to the determined difference exceeding a threshold.

19. The system of claim 17, wherein the processor is further configured to render a subset of the captured plurality of images simultaneously for at least one rendered frame of the first time period.

20. The system of claim 11, wherein the processor is further configured to compare the determined difference between the first position and the second position to a historical log of differences between the first position and additional positions of the corresponding portion of the user's body captured in additional images; and provide a notification to a second computing system, responsive to determining that a trend of the differences exceeds a threshold.
